(19) United States
(12) Patent Application Publication
(10) Pub. No.: US 2012/0195416 A1
(43) Pub. Date: Aug. 2, 2012

(54) Caller ID and Information Display

(76) Inventors: Vince McLean, Phoenix, AZ (US); Sean D. McLean, San Diego, CA (US)

(21) Appl. No.: 13/361,251

(22) Filed: Jan. 30, 2012

Related U.S. Application Data
(60) Provisional application No. 61/462,151, filed on Jan. 28, 2011.

(51) Int. Cl. H04M 11/00

(52) U.S. Cl. 379/93.23

(57) ABSTRACT

The invention provides a caller ID and information display system, comprising means to transmit the information normally displayed on a phone or a base unit's screen to portable panels. The system is also capable of displaying other information such as current local weather conditions, real time monitoring of stock and bond markets, sports scores, winning lottery numbers, daily horoscopes, holidays, birthdays and a multitude of other information.

### CLAIM OF PRIORITY

This patent application claims priority under 35 USC 119 (e) (1) from U.S. Provisional Patent Application Ser. No. 61/462,151 filed Jan. 28, 2012, of common inventorship herewith entitled, “Caller ID and Information Display.”

### FIELD OF THE INVENTION

The present invention pertains to the field of telephone devices, and more specifically to the field of electronic displays with caller identification, voicemail alerts, and current news data.

### BACKGROUND OF THE INVENTION

The prior art has put forth several designs for caller identification systems used with telephones. Among these are:

U.S. Pat. No. 6,748,058 to Peggy S. Schwend, Martin R. Marks, Brent V. Bell, Douglas F. Reynolds and Gloria E. Davy describes a caller identification system with an audible identification capability for callers with blocked or unknown numbers.

U.S. Pat. No. 6,546,092 to Joseph C. Corbett, William I. Fletcher and Alan R. Loudermilk describes a video caller identification displayed on a television.

U.S. Pat. No. 5,883,942 to Boon-Chen Lim and Yeung-How Lim describes a caller ID device and an integrated caller ID and answering machine device.

None of these prior art references describe the present invention.

### SUMMARY OF THE INVENTION

It is an object of the present invention to provide an easily viewable display of caller identification, voicemail functions and news or panels placed on a wall or a desk.

### BRIEF DESCRIPTION OF THE DRAWINGS

FIG. 1 is a perspective front view of a wall mounted display showing a calendar display.

FIG. 2 is a perspective front view of a wall mounted screen showing a background display.

FIG. 3 is a larger perspective front view of a wall mounted screen showing a background display with the incoming caller ID and information.

FIG. 4 is a perspective front view of a wall mounted rectangular screen showing an incoming call and the caller's name.

FIG. 5 is a front view showing five screens with caller ID, voice mail notification, time, date, temperature, horoscope and stock information.

FIG. 6 is a perspective rear view of a picture frame display showing the attached box for electronics and wireless capability.

FIG. 7 is a perspective front view of a picture frame display showing stock information.

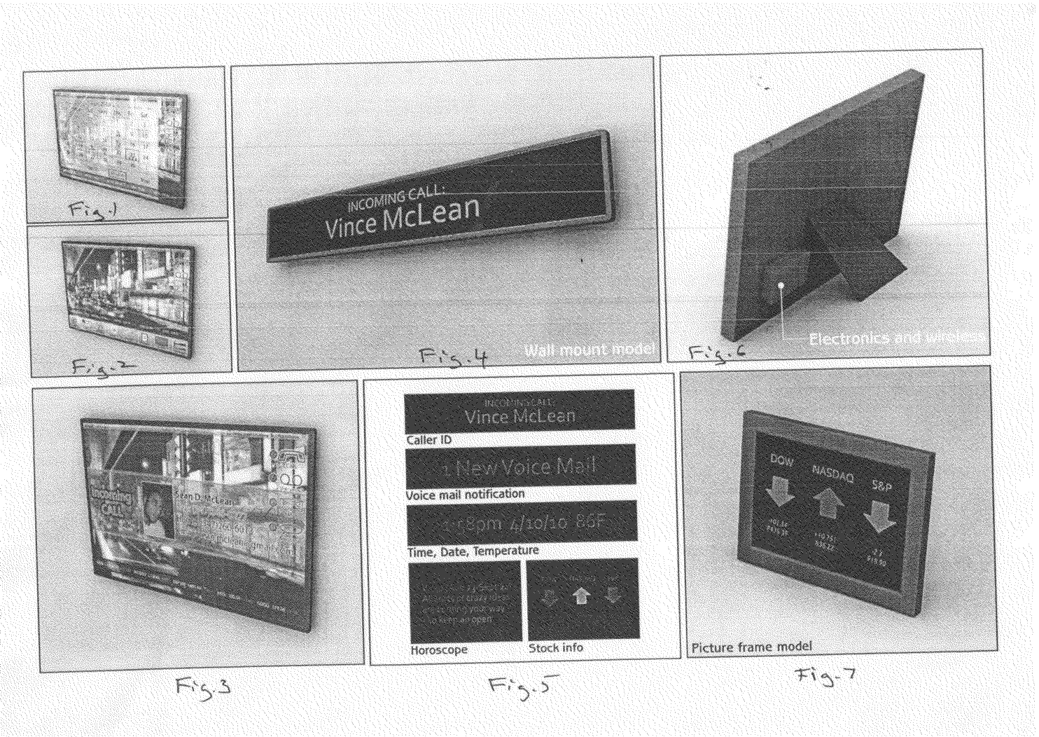

### DETAILED DESCRIPTION OF THE INVENTION

Caller ID and voicemail have become standard features for most telephone users. Caller ID identifies a telephone caller and voicemail enables the caller to leave a message. These are essential components of a home or an office phone. Caller ID and voicemail share a single drawback. One physically has to access a phone receiver to retrieve messages or operate the features on a phone's base unit to retrieve messages.

The present invention, hereinafter referred to as the Caller ID & Information Display, transmits the information normally displayed on a phone or a base unit's screen to portable panels. These panels can comprise any suitable display panel, such as LED, light emitting diode, or LCD, liquid crystal display, for example. The panels can be placed anywhere in the home or office. When a call comes in or a voice message is left, a consumer can monitor these communications without going to the phone or interrupting what he or she is doing. The Caller ID & Information Display is designed for use with conventional corded phones, cordless phones, cell phones, and VOIP, Voice-over-Internet-Protocol phones. The system can be either a wired or a wireless system. The display unit will be designed in two embodiments. The first display embodiment is a rectangle bar in shape, measuring approximately six inches in height by twenty four inches in length and two inches in depth. This embodiment is suitable for wail mounting with a pair of slot and hole mounts. The second display embodiment resembles a picture frame with an easel back for placing on a table or a desk. This embodiment will be approximately four inches in height by six inches in length and one half inch to two inches in depth. The Display screen will utilize light emitting diodes or other means to display the name or number of an incoming caller. The name or number will display in characters large enough to be legible from any area of the room. If the user does not answer the call, the unit proceeds to display a voicemail notification. For conventional corded and cordless landline phones, the Caller ID & Information system employs a plug and a phone cord to receive the relevant information. With a VOIP system, the system relies on the user's WiFi computer transmitter to receive the information. With a cell phone, a small accessory transmitter can be plugged into the phone. The device of the present invention will come complete with CD software to facilitate the moving of data from a computer to the information display by means of a USB connection or WiFi. The software is available to computers, smart phones, tablets and other hand held and non-hand held devices. The Caller ID & Information Display can be programmed by the user to access and display a variety of information beyond that relating simply to phone calls and voicemail. A clock and calendar function can display the time and date. The users can program a display that shows current local weather conditions, real time monitoring of stock and bond markets, sports scores, winning lottery numbers, daily horoscopes, holidays and birthdays, reminders (important events, due dates, prescription refill dates), alarms, titles and lyrics of songs currently playing in the home, timers, new emails, social media feeds such as facebook, twitter, tumblr, google plus, my space, rss, and all other social media feeds, text messages directed from cell phone, list of latest products customers enjoy and date available to purchase product, name of television show or game currently being viewed or played on television at that moment, bank account status alerts, latest local and global news.

Basic functions such as the clock and calendar will be included with all embodiments of the Caller ID & Information Display. The higher functions such as the local weather and sports scores will require the user to have a high speed Internet connection and wireless capability. The Caller ID & Information Display can incorporate multiple display units for installation throughout the house or office. It can include an optional touch screen enabling the user to answer, dial and converse on the phone directly through the display screen.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A caller ID and information display system, comprising means to transmit the information normally displayed on a phone or a base unit's screen to portable panels.

2. The system of claim 1 wherein the panels can comprise any suitable display panel, such as LED, light emitting diode, or LCD, liquid crystal display, and wherein the panels can be placed anywhere in the home or office.

3. The system of claim 1 capable of being used with conventional corded phones, cordless phones, cell phones, and VOIP, Voice-over-Internet-Protocol phones.

4. The system of claim 1 capable of being used with a wired or a wireless system.

5. The system of claim 1 wherein the display unit is a rectangle bar in shape, measuring approximately six inches in height by twenty four inches in length and two inches in depth, and wherein the unit is suitable for wall mounting with a pair of slot and hole mounts.

6. The system of claim 1 wherein the display unit resembles a picture frame with an easel back for placing on a table or a desk, and wherein this unit is approximately four inches in height by six inches in length and one half inch to two inches in depth.

7. The system of claim 1 wherein the display screen utilizes light emitting diodes or other means to display the name or number of an incoming caller.

8. The system of claim 1 wherein the name or number of an incoming call displays in characters large enough to be legible from any area of the room.

9. The system of claim 1 wherein an unanswered call results in voicemail notification.

10. The system of claim 1 configured for conventional corded and cordless landline phones, wherein a phone cord is used to receive the relevant information.

11. The system of claim 1 configured for VOIP system, wherein a WiFi computer transmitter receives information.

12. The system of claim 1 configured for a cell phone, wherein a small accessory transmitter is plugged into the phone.

13. The system of claim 1, further comprising CD software to facilitate the moving of data from a computer to the information display by means of a USB connection or WiFi, wherein the software is available to computers, smart phones, tablets and other hand held and non-hand held devices.

14. The system of claim 13 wherein the system is programmed by the user to access and display a variety of information beyond that relating simply to phone calls and voicemail.

15. The system of claim 1 further comprising a clock and calendar function capable of displaying the time and date.

16. The system of claim 1 further comprising capability of displaying current local weather conditions, real time monitoring of stock and bond markets, sports scores, winning lottery numbers, daily horoscopes, holidays and birthdays.

17. The system of claim 1 further comprising an optional touch screen to answer, dial and converse on the phone directly through the display screen.
